(19) United States
(12) Patent Application Publication
(10) Pub. No.: US 2006/0239777 A1
(43) Pub. Date: Oct. 26, 2006

(54) Portable self-powered recovery system for contaminated fluids

(76) Inventor: Douglas Adams Martin, Wethersfield, CT (US)

Correspondence Address: Douglas Adams Martin, 284 Wolcott Hill Road, Wethersfield, CT, 06109, US

(21) Appl. No.: 11/378,734

(22) Filed: Mar. 18, 2006

Related U.S. Application Data
(60) Provisional application No. 60/674,484, filed on Apr. 25, 2005.

(51) Int. Cl. B09C 1/00

(52) U.S. Cl. 405/128.15

(57) ABSTRACT

The invention is a portable, fully independent, pump-based remediation device and methods for the collection of non-aqueous phase liquids and other fluid contaminants in environmental settings. The device is comprised of a compact, weather-resistant housing equipped with: electric pump; independent power supply; programmable timer and/or sensor; and control and monitoring systems. The device is used in combination with a variety of suitable fluid storage containers. A method for removing fluid contaminants from environmental installations such as groundwater monitoring wells, piezometers, product recovery wells and trenches by transporting said device to the treatment location, installing the fluid storage container, installing the device pump tube systems, connecting safety systems, and programming the timer and/or sensor. Primary advantages over other existing systems include the device's compact, portable size, integrated components, independent power supply, and flexibility in application and installation.

### CROSS REFERENCE TO RELATED APPLICATIONS

This application claims the benefit of U.S. Provisional Application Ser. No. 60/674,484 filed Apr. 25, 2005.

### STATEMENT REGARDING FEDERALLY SPONSORED RESEACH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to devices for the remediation of environmental contamination, specifically the use of portable, fully-integrated pump-based remediation devices to assist in removal of non-aqueous phase liquid (NAPL) and other fluid contaminants from the environment.

The general object of the subject invention is to provide simple, economical means to assist in the remediation of groundwater contaminants. Specifically, the subject device presents a highly-portable, self-powered and automated system to recover NAPL and other fluid contaminants. Ideally the device and methods described herein are suitable to enable an individual to transport, install, and operate an effective remediation system for fluid contaminants under a variety of scenarios and field conditions.

A range of fluid contaminants may be found in the environment as a result of historical industrial and/or commercial activities, which pose significant, long-term environmental and/or human health hazards. Fluid contaminants which may be encountered at industrial or commercial sites include NAPLs as well as dissolved-phase constituents of concern in groundwater. NAPLs may be light NAPL (LNAPL) which have a specific gravity less than water and therefore are often found at the groundwater table, or dense NAPL (DNAPL), which have a specific gravity greater than water and may often be found at depths below the water table. DNAPLs are particularly challenging to identify and remediate due to their ability to migrate vertically to significant depths, and in some instances, long distances laterally from their points of original deposition. LNAPLs frequently found in former industrial settings involve petroleum products, including gasoline, fuel oils, hydraulic oils, aviation fuels, and other crude oil derivatives. These products are often encountered at refineries, tank farms, airports, filling stations, utility facilities, and other facilities where large volumes of these materials have historically been stored, used and/or disposed. DNAPLs that may be identified in the environment include chlorinated solvents, creosote, manufactured gas plant (MGP) tars, and other industrial feedstock chemicals and products. These wastes can be found at a wide range of utility and industrial sites including metalworking facilties, drycleaning establishments, wood-treatment plants and former MGP sites.

NAPLs pose significant long-term challenges due to their common presence, their propensity to migrate in the environment, and the inherent toxicity of their constituents to human health and/or the environment. While some NAPLs such as chlorinated solvents consist predominantly of one chemical compound (e.g., trichloroethylene), materials such as petroleum products and MGP tars are comprised of hundreds of constituents that may be of environmental concern. Some of those constituents are relatively water soluble and therefore are prone to dissolution in the surrounding groundwater, which can enhance dissemination into the surrounding environment via groundwater migration. NAPLs present a long-term, concentrated source of such contaminants; a finite amount of NAPL in conducive conditions may provide an ongoing source of dissolved-phase constituents of concern (e.g., benzene, methyl-tert-butyl ether, naphthalene, chlorinated compounds). In some instances, the release and distribution of these constituents may be coupled with their natural transformation to other more toxic forms (e.g., degradation of perchloroethylene to vinyl chloride).

NAPLs continue to confound the regulatory and environmental communities due to the technical challenges posed by their physical/chemical characteristics and their migration potential. Thus, their control or removal from the environment is often deemed to be the prudent course of action. Recovery of LNAPLs may be a relatively straight forward process due to their tendency to accumulate at the water table surface. While recovery of LNAPL is often expected and/or required under federal and state environmental regulations, requirements directing the recovery of DNAPLs are less consistent. The United States Environmental Protection Agency (USEPA) and many state environmental agencies acknowledge the technical difficulties associated with the control/recovery of DNAPLs. In some specific instances, the regulatory term “technical impracticability” is used to justify the inability to mitigate certain DNAPL-related problems. Typically, however, the removal of NAPL is often required to the extent practicable.

Specifically, the subject remediation device has been developed to provide a simple, portable and flexible means to remove accumulated NAPL in monitoring wells, piezometers, product recovery wells, and containment systems (e.g., barrier walls), or other structures where such material accumulates. For passive accumulation/recovery of NAPL, periodic phased recovery is often the most effective method to maximize the volume of recovered material over time. A pulsed recovery process removes the accumulated product, which due to its specific gravity, may displace more than the actual NAPL-saturated thickness of soils that is present. Appropriately-timed or phased removal will reduce the pressure imparted by the standing column of product, thereby enhancing continued passive flow into the well. Over-pumping of NAPL may alter favorable capillary pressures within the geologic unit, thereby reducing recovery efficiency. For these reasons, appropriate removal rates should be established to optimize NAPL removal.

Presently, there are no commercially-available, portable, self-contained NAPL recovery systems of this nature (that have been identified by the Inventor) that can be readily used at such sites. In addition, no comparable patented devices have been identified. To date, the means to accomplish such removal have largely been labor intensive, requiring periodic mobilization of personnel to a site to recover the accumulated material using predominantly manual methods, including bailers, pumps, absorbent devices, etc. Although a variety of systems exist which are capable of recovering fluid contaminants in the environment, none identified by the Inventor were of comparable size, configuration and/or operation or were suitable for simple installation under a wide range of installation scenarios. Current installations typically require preliminary evaluation, design, construction, installation, and troubleshooting before active recovery can be initiated. The generic device types covered under existing U.S. Pat. No. 6,428,694, for example, present similar requirements for conceptual design and configuration of components. Further, none of the identified systems present the portability and self-sufficiency that is afforded by the subject invention. The time, labor and costs for these systems may also be prohibitive, particularly considering the limitations inherent in any passive recovery program, particularly for DNAPLs. Thus, there is an apparent need for an economical, pre-configured device that is highly portable, independent of external power requirements, and flexible for a variety of installation configurations. The subject device described herein has been developed to present these significant advantages.

### BRIEF SUMMARY OF THE INVENTION

The remediation device and methods described herein have the capability to provide both short- and long-term recovery of fluid contaminants, depending on the application. The invention may enable a single individual to transport, install, initiate and monitor the system. Particularly suitable conditions for application of the proposed system include, but are not limited to:
Situations where NAPL is encountered in sampling installations, such as groundwater monitoring wells or piezometers;
Remote locations that are devoid of suitable power services;
Initial systems for contaminated sites where the extent/volume of recoverable NAPL has not yet been established;
Temporary installations that can provide initial product recovery before the design and construction of larger-scale, permanent installation can be completed; and
Installations with challenging physical conditions, such as flooding or limited accessibility.

The remediation device described in this application has been developed to address all of these conditions, and to provide a simple, economical means to recover passively-accumulated NAPL or other fluid contaminants where it is called for.

### BRIEF DESCRIPTION OF THE SEVERAL VIEWS OF THE DRAWING

FIG. 1 depicts a stylized side view cross-section of one embodiment of the remediation device depicting all primary components. These include: device housing 1; electric pump 2; control systems 3, including timer relay and cycle counter; independent power supply 4; photovoltaic cell 5; and fluid storage container 6, equipped with float shut-off switch 7.

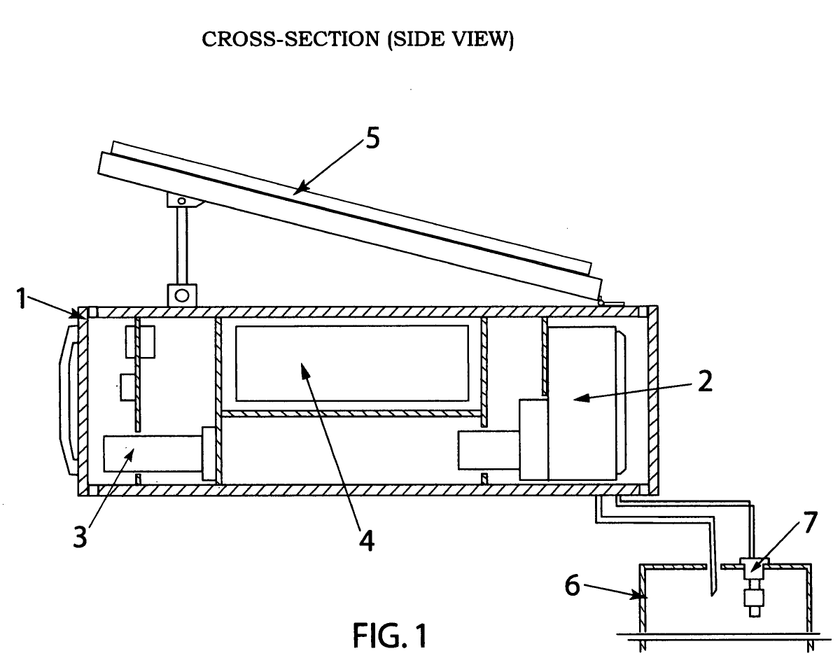

FIG. 2 presents an example wiring diagram of one tested embodiment of the device. The schematic is presented for a recovery device with the following components: 12-volt peristaltic pump 2; programmable timer unit 3; 12-volt or 24-volt deep cycle battery 4; 5-watt photovoltaic cell 5; float-actuated cut-off switch 7; electronic temperature switch 8; and pump cycle counter (with separate battery) 9. Activation of the device systems is controlled by one or more electric switches 10. A fuse 11 provides protection of device circuitry and components. FIG. 2 is provided as an example wiring configuration to highlight the relationship between system components, however, specific wiring arrangements may vary from the example, depending upon the type and brand of components, as well as the addition of potential other system amendments.

FIG. 3A and FIG. 3B illustrate two example remediation device installations. FIG. 3A depicts a typical installation within a groundwater monitoring well equipped with a protective stickup casing. FIG. 3B depicts a typical installation within a flush-mount groundwater monitoring well. Both examples depict the relative placement of the remediation device 1 adjacent to or resting directly upon a fluid storage container 6, which may consist of an inner (primary) and outer container to provide secondary containment protection. In FIG. 3A, the remediation device 1 is attached to a rigid stand 14 immediately adjacent to the monitoring well 13 and the fluid storage container 6. In FIG. 3B, the remediation device 1 is secured directly to the top of the outer fluid storage container 6. In both examples, the photovoltaic cell 5 is affixed to the adjustable framework on top of the remediation device 1, with the angle and orientation established to provide optimal exposure for electrical power generation. In both examples, chemical-resistant, rigid-walled product recovery tubing 12 extends from the remediation device pump inlet to the bottom of the monitoring well 13. A separate section of chemical-resistant, rigid-walled tubing 15 directs the fluid discharge from the remediation device pump outlet to the fluid storage container 6. An electric float switch 7 is installed within the top of the primary fluid storage container to shut-down the system when the switch detects a high fluid level condition within the fluid storage container 6.

### DETAILED DESCRIPTION OF THE INVENTION

The presented remediation device is designed to provide a simple, highly-portable, independent system for the collection of fluid contaminants. The device design consists of five primary systems: the device housing, control systems, independent power supply, pump system, and fluid storage.

Device housing is sufficiently compact, weather-resistant, and designed to fully enclose said components while affording ready access for periodic maintenance and settings. One effective embodiment consists of a plastic housing equipped with two gasketed, hinged ports to allow access to the internal components. The container is of sufficient size to contain or incorporate all of the identified components except the fluid storage container, and is of a flexible configuration to enable a variety of installation methods. The access ports are outfitted with locks to prevent unauthorized access or vandalism to the interior components.

Housing construction may include a variety of attachment systems (e.g., bolts, clamps, etc.) which will allow a range of installation arrangements depending on the given application. Several example attachment systems include, but are not limited to, the following systems:
Threaded bolts that will facilitate connection of the unit to a stand, well stick-up, or other fixed structure using metal straps, cables or other means;
Screw bolt(s) that will facilitate attachment of security locking systems (e.g., metal chains and cables); and
Foot pads or other fixtures to allow the unit to be mounted directly on the fluid storage container, or other suitable flat surface.

Secondary containment of the pump assembly may be afforded through incorporation of gasket seals to isolate the pump chamber from other internal device components, as well as the exterior environment.

Control systems may include a timer, sensor or other means to control recovery rate of the system, and various safety systems which will ensure that the system does not operate when the fluid storage container is full or adverse operating conditions (e.g., extreme temperatures) are present. One such embodiment uses an Artisan Controls Model 2601SA-2 electronic timer relay, which allows the setting of separate timed operation and delay cycles up to 1024 hours. Another application involves use of a fluid sensor, such as a Levelite Optic Level Switch and Pump Controller equipped with an infrared turbidity probe, which can detect when the target fluid level reaches a pre-defined level, which then signals the pump to activate. A variety of other sensor types (e.g., conductance, optical, acoustic, etc.) that are effective at differentiating the specific target fluid may also be used. Another potential supplemental system is an electronic temperature switch (e.g., Love Model TS-13030 Digital Temperature Switch) which will monitor ambient temperature and shut-down the system when extreme conditions (e.g., freezing temperatures) exist.

The independent power supply ensures that the system is fully self-sufficient and requires no separate power sources. One such embodiment consists of a compact deep-cycle 12-volt battery combined with a solar photovoltaic cell with sufficient capacity to maintain adequate level of charge in the battery. One tested system consisted of a 12-volt, 23-amp hour deep cycle sealed gel cell battery combined with a 12-inch by 12-inch 5-watt photovoltaic cell. Ideally, the power supply is of appropriate size to enable incorporation into the system housing; this will simplify the installation and reduce the possibility of incidental damage to the associated wiring harness. Further, the system may be modified to enable use of an AC/DC transformer in the event AC service becomes available at the point of system installation. The power supply system may also incorporate current overload protection in the form of one or more properly rated fuses, to prevent damage to the device's internal electrical components.

The pump system consists of a self-priming, positive-displacement pump with sufficient suction-lift capacity and chemical resistance to effectively transfer fluid contaminant from its original location to the surface and direct it to the fluid storage container. One effective pump system consists of an Autoclude Model M1500 Peri-pump peristaltic pump with 65 rpm gearbox and equipped with eight millimeter thick-wall, chemical-resistant (e.g., Viton®) pumphead tubing, which provides an approximate flow rate of 600 milliliters per minute. Advantages of this type of pumping system are its self-priming capability and limitation of fluid contaminant contact to the interior of the pump-head tubing and down-well tubing. Thus, no actual pump components are directly contacted by the fluid contaminant, which may be chemically aggressive. The suction-lift capacity of a typical peristaltic pump is approximately 25 feet of head, which is adequate for many contaminated sites where the water table is located less than 25 feet below ground surface. Other pump systems that can provide adequate suction-lift and remain resistant to chemical deterioration may be used where suitable. Secondary containment of the pump tubing may be achieved by installation of larger diameter tubing over the primary pump tubing and affixing it to divert all potential leakage to the fluid storage container. One effective configuration involves the application of flexible PVC bilge pump hose over the primary pump discharge line, which could potentially leak during pump operation. Both the primary discharge tube and outer hose are directed to fixtures in the lid of the fluid storage container.

Fluid Storage consists of a secure vessel of sufficient size, chemical resistance, and configuration to allow secure storage of the target fluid contaminants. One effective system consists of a 30- or 55-gallon steel DOT-approved drum placed within an enclosed secondary container (e.g., drum overpack). These containers are readily available, economical, and proven systems for collection, storage and transport of fluid contaminants. Larger fluid storage containers (e.g., storage tanks) may be used to provide greater storage capacity of recovered fluid contaminants. The fluid storage container may also be equipped with a safety system (see Control systems above), such as a float switch (e.g., Madison Liquid Level Switch M8800-PR), which will automatically shut down operation of the remediation device when the container becomes filled.

Construction of the remediation device may involve manufacturing of an appropriate system container or procuring one of suitable construction and configuration from available commercial sources. The container must be of adequate size to fully enclose all of the necessary components, yet compact to provide the advantage of portability. The container must also be weatherproof for all internal components susceptible to moisture (e.g. electronics) and to keep out pests. The container must also enable easy access to all components in the field. Construction of the container may be of a variety of typical construction materials (wood, fiberglass, plastics, suitable laminates, etc.) as long as the completed unit provides the aforementioned features. One example of a constructed system consisted of a weatherproof NEMA 4X control box containing the system electronics coupled with a weatherproof, polyester resin impregnated plywood box for the pump and photovoltaic cell assemblies. Another example utilized a surplus military container, which was modified by installing equipment panels and configured to hold all of the indicated systems components to provide a compact, secure weatherproof housing.

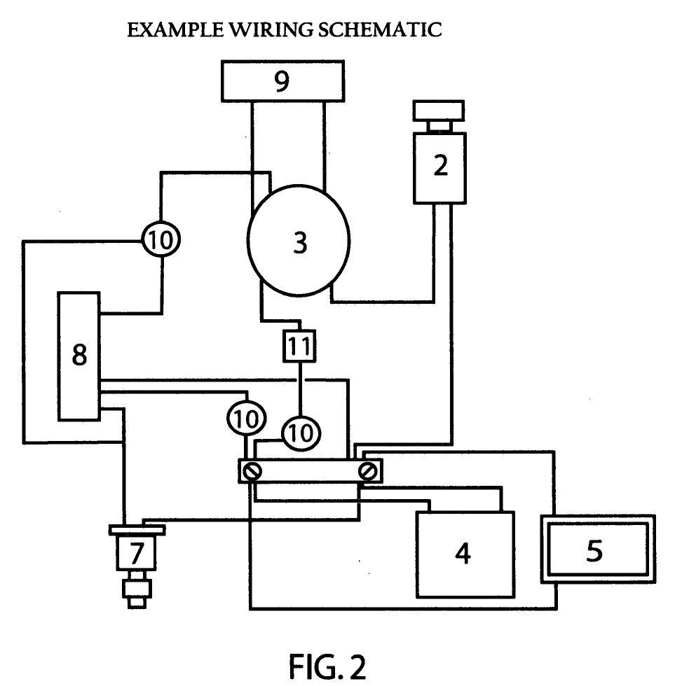

Once an appropriate container has been secured, installation of the internal components can be completed. All electrical connections must be made to provide a clear, organized wiring scheme to facilitate any repairs/modifications, using secure connections (soldered, solderless, or other) to ensure reliable, moisture-resistant contacts/circuits. FIG. 2 presents an example wiring diagram for systems encompassing these components.

All internal bulkheads and mounting brackets should be secure and constructed of robust, moisture-resistant materials. All penetrations of the outer container for external connections, ports, etc. must be weatherproof, using appropriate seals, sealants and/or gasketed components. Suitable means for attachment of the final container for installation should be incorporated into the final product to facilitate field installation. Mounting systems may include bolts, brackets, straps, etc. of sufficient simplicity and strength for the planned application and to allow access to all necessary components (i.e., for settings, battery inspection/replacement, wiring inspection). Once all components are installed appropriately, and the wiring is completed, the battery may be installed within the container, or attached externally. Methods for attachment in the final field installation should be incorporated into the unit before mobilization to the field in order to simplify final installation. In addition, a desirable feature is the provision of attachments for secondary containment of the pump tubing to capture and direct any leakage from the primary tubing to the fluid storage container.

Upon mobilization to the installation site, the fluid storage container is placed adjacent to the location where fluid is to be recovered. A pre-measured length of chemical-resistant, non-collapsible tubing is then inserted into the well or other receptacle where fluid contaminant is to be recovered. Care should be taken to cut the tubing at an angle and/or attach a suitable stand-off device to preclude clogging or obstruction of the pump tube end. Addition of a screen on the end of the tubing will minimize pumping of debris. Once the recovery tubing section has been installed, the other end may be affixed to the inlet port of the remediation device. A second section of tubing is then attached to the outlet port of the system and the opposite end placed into the storage container through a bung or other prepared orifice. The outer, secondary containment hose is then affixed to these tubes. Most installed systems should have some form of shut-off system to prevent overfilling of the fluid storage container. One such mechanism consists of an electric float-switch connected to the device to shut off the system when the float is raised by the recovered fluid level at a pre-defined height. Wiring schematic for one such system is provided in FIG. 2. Following completion of these steps, the system can then be affixed to the fluid storage container, fixed mount, or simply rested on a level surface. The system may then be programmed and tested before leaving it in operational mode. If a timer system is used as the control system, appropriate time cycles should be estimated for the actual pumping cycle and for the delay cycle. Delay times will be primarily dependent on the volume of the fluid contaminant to be removed, its physical characteristics (e.g., viscosity), and its rate of accumulation. Periodic checking for proper operation is recommended, with periodic removal of the recovered fluids from the fluid storage container. Inspection of the pump cycle timer/counter will enable the user to determine that the system is functioning as intended.

Examples of the best mode(s) for use of the invention are described below. The remediation device and methods that are the subject of this application are intended to provide an effective means to recover NAPL or other fluid contaminants under a broad range of potential applications and scenarios. Key features are compact/portable size, robust, weatherproof construction, effective recovery capability, simple yet flexible installation systems, and simple setup and operation. In general, the best mode for use involves the installation of the devices to remove passively accumulating fluid from an existing monitoring well, tank, sump or other location. Conditions may vary, but these scenarios often involve installations in locations far removed from reliable power sources, having difficult access, and temporary in nature. Two example systems which represent a range of potential applications, are described below.

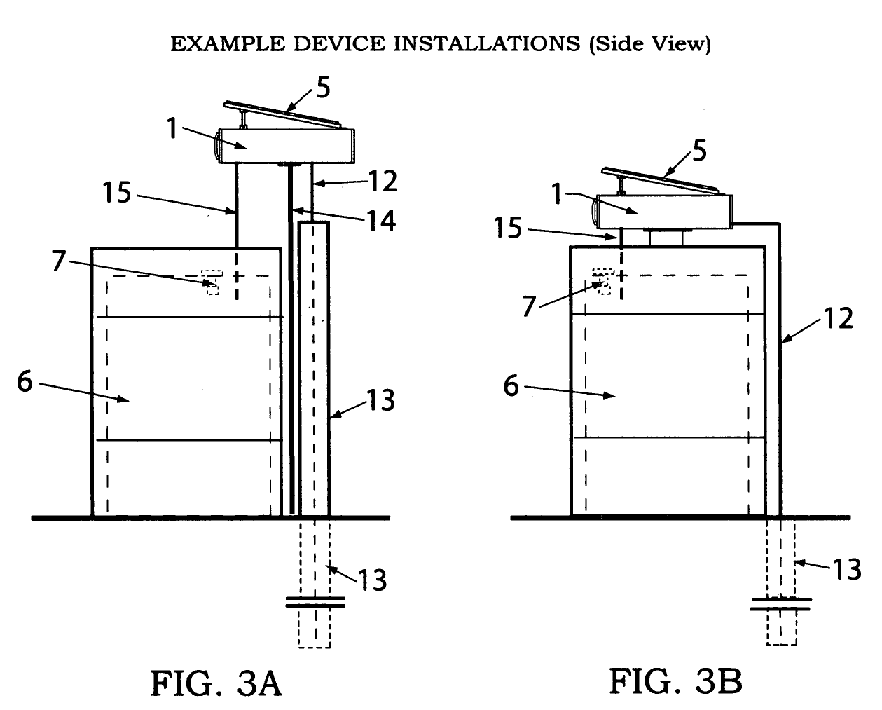

One example remediation device was installed in a river flood zone that is periodically inundated during periods of heavy precipitation (refer to FIG. 3A). The system was installed to remove DNAPL coal tar that periodically accumulated in a two-inch diameter monitoring well, at a depth of 20 feet below grade. Installation considerations included the remote location with limited physical accessibility, absence of an accessible power source, and periodic flooding at the location of the monitoring well, with temporary depths of up to six feet above ground surface. The device was mounted on a steel pole, which was secured to the protective well casing. A 55-gallon drum placed within a steel 95-gallon overpack drum, was secured to the well casing using locking chain-clamps, to provide secure, double containment for the recovered tar. The primary remediation device remained effectively above flood waters, although the fluid storage container was periodically submerged during flood events. This example illustrates an extreme installation where the advantages of the subject design are clearly evidenced.

A second example remediation device, which illustrates the suitability of the system for periodic or short-term applications, involved an installation in the center of an active construction site, as a temporary installation (refer to FIG. 3B). The application involved passive recovery of DNAPL coal tar in a 1.5-inch diameter monitoring well, from a depth of 30 feet below grade. The device was bolted to the top of the overpack drum, with pump lines directed up through PVC protective piping to the remediation device. No significant modifications to the pre-configured device were required for the installation, although a protective screen was installed on the photovoltaic cell to prevent vandalism. Following shutdown, demobilization of the device required only the unbolting of the unit from the overpack lid, removal of the down-well tubing and protective casing, and removal of the collected tar product in the overpacked steel drum.

It is understood that, based on the disclosure provided herein, the system of the present invention, or portions thereof, and the functionality described in connection therewith, can be implemented in many different ways by one of ordinary skill in the art. It is also understood that the examples and embodiments described herein are for illustrative purposes only and that various modifications or changes in light thereof will be suggested to persons skilled in the art and are to be included within the spirit and purview of this application and scope of the appended claims.

The invention claimed is:

1. A portable remediation device for use in removing fluid contaminants from subsurface installations, said device comprising:
housing, which contains and protects the stated device components;
electric-powered pump;
programmable controller;
independent power supply;
fluid storage container for collection and temporary storage of fluid contaminants;
dedicated inlet and outlet pump tube systems for connection to said remediation device for transfer of said fluid contaminant from the environment to said fluid storage container;
system shut-off device to cease operation of said system when said fluid storage container has been filled to capacity.

2. The remediation device of claim 1, wherein said housing contains said components other than said fluid storage container, in a compact, portable configuration;

3. The remediation device of claim 2, wherein said housing is robust, weather-resistant, and pest resistant;

4. The remediation device of claim 3, wherein said housing may be equipped with lockable or non-lockable attachment systems to secure said device in-place;

5. The remediation device of claim 4, wherein said housing may include provision for double-containment of all fluid transfer systems that may become pressurized during said pump cycle operation. or that otherwise have the potential to leak;

6. The remediation device of claim 5, wherein said housing configuration enables access to said components specified in claim 1 via access panels, doors or other effective means;

7. The remediation device of claim 6, wherein said housing may incorporate means to affix locks or other effective means to restrict unauthorized access to said system components;

8. The remediation device of claim 7, wherein said housing may incorporate one or more external handles, straps, or other effective means to facilitate movement, transport and installation of said remediation device;

9. The remediation device of claim 1, wherein said pump may consist of a direct-current powered peristaltic pump equipped with chemical-resistant pump head tubing, or other suitable self-priming, positive displacement pump with suitable suction-lift, pumping rate, and energy-consumption specifications;

10. The remediation device of claim 1, where said programmable controller consists of an electronic timer or other suitable device capable of being programmed to establish said pump operation cycle and/or system time delay cycles;

11. The remediation device of claim 10, which may include a sensing unit capable of detecting the presence, level and/or quantity of target fluid contaminant to actuate said pumping cycle;

12. The remediation device of claim 1, where said power supply consists of a battery or other portable power supply, of suitable voltage and amp-hours to operate said remediation device at the required pumping cycle duration, for the required period of operation;

13. The remediation device of claim 12, which may include a photovoltaic cell of sufficient wattage to maintain the necessary voltage and amperage in said power supply throughout said period of operation, if required;

14. The remediation device of claim 1, whereby said fluid storage container for collection and temporary storage of recovered fluid contaminants may be integrated into the device configuration, or provided as a separate component at the time of installation of said remediation device;

15. The remediation device of claim 1, which may include a cycle timer or other tallying device that records the totaled level of said pump activity;

16. The remediation device of claim 1, which may include one or more safety shut-off devices to preclude system operation in adverse conditions;

17. The remediation device of claim 1, which may include the addition of a data telemetry system for transmission of said remediation device system status and/or fluid recovery status.

18. A method of removing fluid contaminants from subsurface installations, comprising:
installing said remediation device at the desired treatment location for recovery of said fluid contaminant;
installing said fluid storage container adjacent to said remediation device (if not an integral device component) and attaching integrated pump tube systems and safety shut-off system(s);
positioning the pump suction tube assembly at the level determined to optimize target fluid contaminant recovery;
setting timer and/or fluid level sensor systems to optimize recovery of fluid contaminant;
monitoring operation of said remediation device during the active recovery period; and
transferring and removing the collected target fluid contaminant for final disposition when said fluid storage container becomes filled.

19. The method of claim 18, wherein said remediation device is installed as a raised installation by affixing said device to a protective stick-up casing of a monitoring well, piezometer, product recovery well or other similar fixed structure;

20. The method of claim 18, wherein said remediation device is mounted and secured directly to the top of said fluid storage container;

21. The method of claim 18, wherein said remediation device is placed on the ground surface or other suitable stable surface, in proximity to the subsurface installation.
